(19) United States
(12) Patent Application Publication
(10) Pub. No.: US 2005/0250400 A1
(43) Pub. Date: Nov. 10, 2005

(54) Temperature sensitive color variable fabric

(75) Inventor: Ben Hsu, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: Ching Feng Blinds Ind. Co., Ltd.

(21) Appl. No.: 10/890,113

(22) Filed: Jul. 14, 2004

(30) Foreign Application Priority Data
May 5, 2004 (TW) 093206972

(51) Int. Cl. B32B 5/02

(52) U.S. Cl. 442/59

(57) ABSTRACT

A temperature sensitive color variable fabric includes a cloth fabric or plastic fabric coated with a layer of printing ink to form diagram-decorated and color-changeable variation areas distributed at the surface thereon wherein the variation areas thereof are made up of temperature sensitive chemicals and color variable chemicals that are preset in different density. A transparent protective film of acrylic plastic is coated at the upper surface of the variation areas thereon to prevent the wearing or shading off of the variation areas thereof for protection thereby. In practical use, the cloth fabric or plastic fabric is capable of being applied to a wrapped covering of an ironing stand or a shower screen, etc. Once in contact with the heat generated by an iron or hot water, the variation areas thereof, via the temperature sensitive chemicals and the color variable chemicals contained therein, can sensitively respond to the change of temperature and variously display the diagrams in different tones of colors, effecting an appealing and fresh visual effect to improve the quality of daily life and attract the curiosity of children for bathing as well as providing a warning function to indicate the temperature reached so as to ensure the safety in the household.

### BACKGROUND OF THE INVENTION

The present invention is related to a temperature sensitive color variable fabric, including a cloth fabric or plastic fabric with diagram-decorated and color-changeable variation areas distributed at the surface thereon and a transparent protective film coated at the upper surface of the variation areas thereon to prevent the wearing or shading off of the variation areas thereof, whereby, the cloth fabric or plastic fabric is capable of being applied to a wrapped covering of an ironing stand or a shower screen, etc. Once in contact with the heat generated by an iron or hot water, the variation areas thereof, via temperature sensitive chemicals and color variable chemicals contained therein, can sensitively respond to the change of temperature and variously display the diagrams in different tones of colors, effecting an appealing and fresh visual effect to improve the quality of daily life and attract the curiosity of children for bathing as well as providing a warning function to indicate the temperature reached so as to ensure the safety in the household.

Please refer to FIG. 1. A conventional fabric for a wrapped covering of an ironing stand or a shower screen is made up a cloth fabric or a plastic fabric 10 simply coated with a layer of printing ink to form diagram-decorated areas 11 distributed at the surface thereon. In practical use, the diagram-decorated areas 11 thereof are fixedly preset in colors without any variations, which cannot improve the quality of daily life or appeal to children for bathing. Besides, such conventional fabric thereof also fails to indicate the temperature of an iron and hot water for warning purpose. And, after long terms of use, the diagram-decorated areas 11 also tend to wear or shade off in diagrams/colors and thus lose the fresh appearance thereof.

### SUMMARY OF THE PRESENT INVENTION

It is, therefore, the primary purpose of the present invention to provide a temperature sensitive color variable fabric, including a cloth fabric or plastic fabric with diagram-decorated and color-changeable variation areas distributed at the surface thereon that is capable of being applied to a wrapped covering of an ironing stand or a shower screen in the bathroom, etc. wherein, once in contact with the heat generated by an iron or hot water, the variation areas thereof, via temperature sensitive chemicals and color variable chemicals contained therein, can sensitively respond to the change of temperature and variously display the diagrams in different tones of colors, effecting an appealing and fresh visual effect to improve the quality of daily life and attract the curiosity of children for bathing as well as providing a warning function to indicate the temperature reached so as to ensure the safety in the household.

It is, therefore, the second purpose of the present invention to provide a temperature sensitive and color variable fabric wherein a transparent protective film of acrylic plastic is coated at the upper surface of the diagram-decorated and color-changeable variation areas thereon, efficiently preventing the wearing or shading off of the variation areas thereof for protecting and prolonging of the using lifetime thereof.

### BRIEF DESCRIPTION OF THE DRAWINGS

FIG. 1 is a cross sectional view of a conventional fabric for a wrapped covering of an ironing stand or a shower screen.

FIG. 2 is a perspective view of the present invention.

FIG. 3 is a cross sectional view of the present invention.

FIG. 4 is a diagram showing the present invention applied to an ironing stand.

FIG. 5 is another diagram showing the present invention applied to a shower screen.

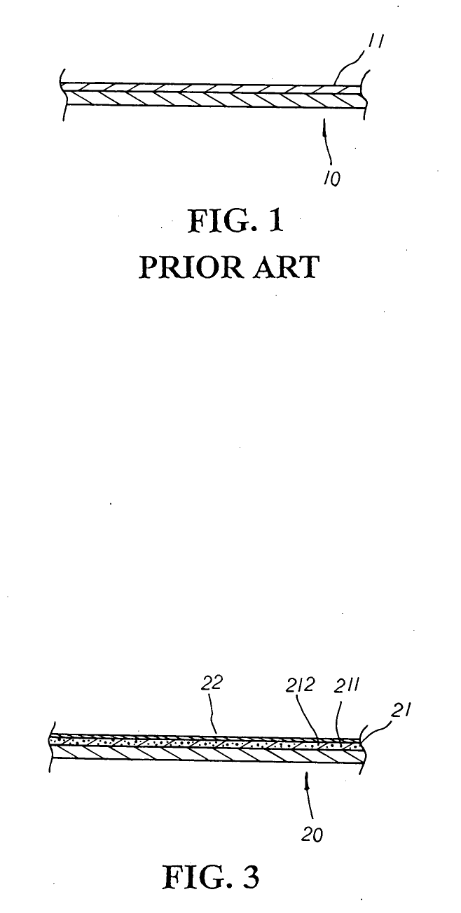

### DETAILED DESCRIPTION OF THE PREFERRED EMBODIMENTS

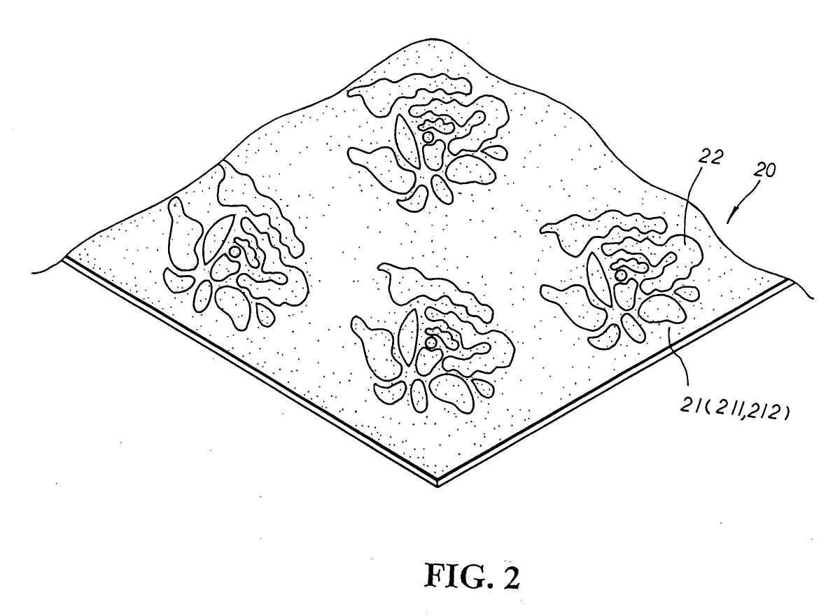

Please refer to FIGS. 2 to 3 inclusive. The present invention is related to a temperature sensitive color variable fabric, including a cloth fabric or plastic fabric 20 coated with a layer of printing ink to form diagram-decorated and color-changeable variation areas 21 distributed at the surface thereon. The diagram-decorated and color-changeable variation areas 21 thereof are made up of temperature sensitive chemicals 211 and color variable chemicals 212, and the color variable chemicals 212 contained in each of the variation areas 21 thereof are capable of being preset in different density. A transparent protective film 22 made of acrylic plastic is coated at the upper surface of the variation areas 21 thereon for protection thereby as shown in FIG. 3.

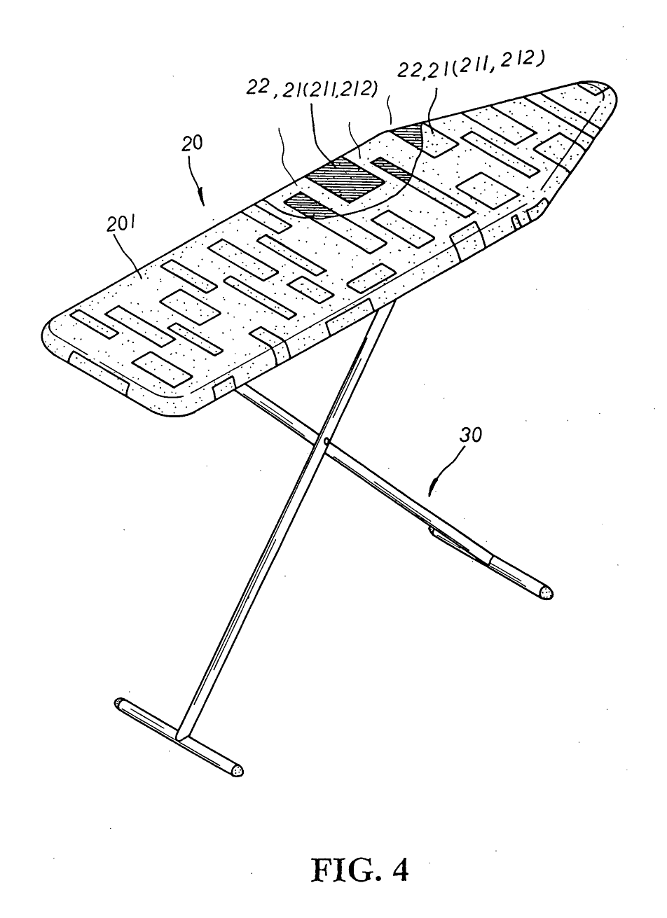

Please refer to FIG. 4. In practical use, the cloth fabric or plastic fabric 20 is capable of being applied to a wrapped covering 201 of an ironing stand 30. Once in contact with an iron placed thereon, the variation areas 21, via the temperature sensitive chemicals 211 and the color variable chemicals 212 contained therein, can sensitively respond to the heat generated by the iron and variably change into different colors according the temperature of the iron thereof. Thus, the diagram-decorated and color-changeable variation areas 21 thereof can not only change in colors for variation thereof, but can also indicate the temperature the iron reached to serve a warning function for the safety in daily life.

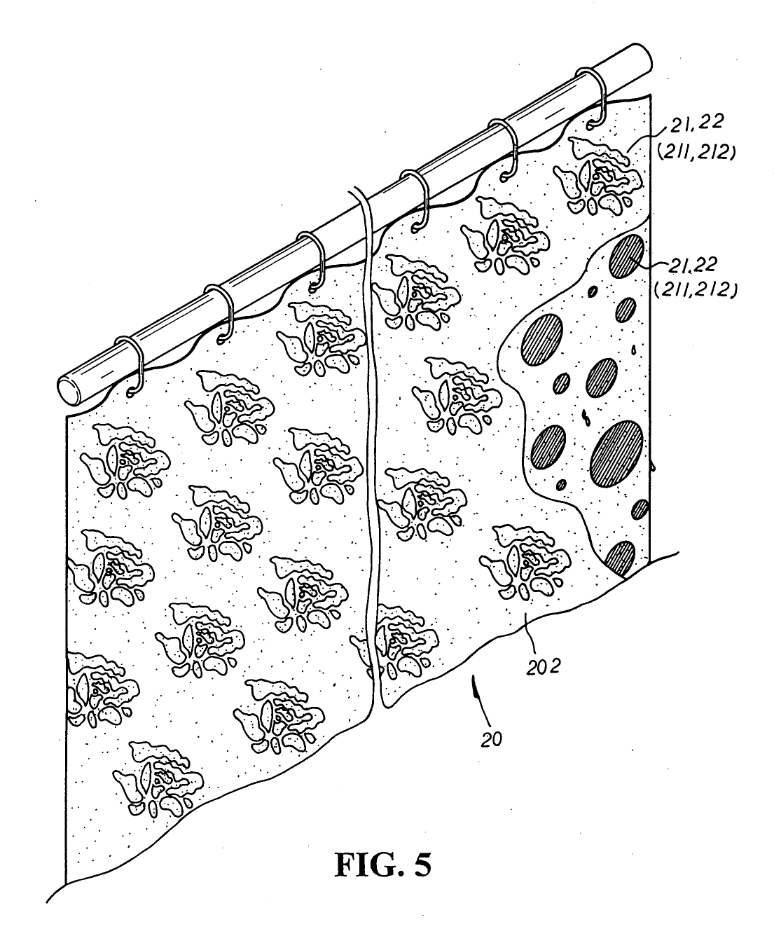

Please refer to FIG. 5. The cloth fabric or the plastic fabric 20 can also be applied to a shower screen 202 in the bathroom. Once in contact with the heat generated by hot water, the variation areas 21, via the temperature sensitive chemicals 211 and the color variable chemicals 212 therein, can sensitively feel the change of temperature and variously display the diagrams in different tones of colors, providing a totally new and fresh visual effect to the show screen 202 thereof to improve the quality of daily life. Thus, the diagram-decorated and color-changeable variation areas 21 thereof not only provide appealing and colorful changes to attract the curiosity of children for bathing, but also serve a warning function to indicate the temperature the hot water reached to ensure the safety in the household.

Furthermore, the diagram-decorated and color-changeable variation areas 21 can also be applied to cover the whole surface of the cloth fabric or plastic fabric 20 thereon wherein the density of the temperature sensitive chemicals 211 is variously distributed at the different or the same positions of the variation areas 21 therein so that all shades of colors are displayed by gradation at the variation areas 21 thereon according to the heat of hot water or moisture cast onto the variation areas 211 in different angles or positions thereof

1. A temperature sensitive color variable fabric, including a cloth fabric or plastic fabric coated with a layer of printing ink to form diagram-decorated and color-changeable variation areas distributed at the surface thereon; the present invention being characterized by that,
the diagram-decorated and color-changeable variation areas being made up of temperature sensitive chemicals and color variable chemicals, and a transparent protective film being coated at the upper surface of the variation areas thereon to prevent the wearing or shading off of the variation areas thereof for protection thereby;
in practical use, the cloth fabric or plastic fabric is capable of being applied to a wrapped covering of an ironing stand or a shower screen in the bathroom, etc.; once in contact with the heat generated by an iron or hot water, the variation areas thereof, via the temperature sensitive chemicals and the color variable chemicals contained therein, can sensitively respond to the change of temperature and variously display the diagrams in different tones of colors, providing a totally new and fresh visual effect to improve the quality of daily life; thus, the diagram-decorated and color-changeable variation areas thereof not only provide appealing and colorful changes to attract the curiosity of children for bathing, but also serve a warning function to indicate the temperature reached to ensure the safety in the household.

2. The temperature sensitive color variable fabric as claimed in claim 1 wherein the color variable chemicals contained in each of the diagram-decorated and color-changeable variation areas thereof are capable of being preset in different density.

3. The temperature sensitive color variable fabric as claimed in claim 1 wherein the transparent protective film thereof can be made of acrylic plastic.

4. The temperature sensitive color variable fabric as claimed in claim 1 wherein the diagram-decorated and color-changeable variation areas can also be applied to cover the whole surface of the cloth fabric or plastic fabric thereon, and the density of the temperature sensitive chemicals is variously distributed at the different or the same positions of the variation areas therein so that the variation areas can variously display the diagrams in all shades of colors gradated from top to bottom or vice versa according to the temperature of hot water or heated moisture cast thereon.
